(19) United States
(12) Patent Application Publication
(10) Pub. No.: US 2013/0014849 A1
(43) Pub. Date: Jan. 17, 2013

(54) FLEXIBLE UNBONDED PIPE AND AN OFFSHORE SYSTEM

(71) Applicant: Kristian Glejbol, Glostrup (DK)

(72) Inventor: Kristian Glejbol, Glostrup (DK)

(73) Assignee: NATIONAL OILWELL VARCO DENMARK I/S, Brondby (DK)

(21) Appl. No.: 13/637,721

(22) PCT Filed: Mar. 30, 2011
(86) PCT No.: PCT/DK11/50102

§ 371 Date: Sep. 27, 2012

(30) Foreign Application Priority Data
Mar. 31, 2010 (DK) PA 2010 00271

(51) Int. Cl. F16L 11/00

(52) U.S. Cl. 138/137

(57) ABSTRACT

The invention provides a new family of flexible unbonded pipes. The flexible unbonded pipe of the invention comprises an internal sealing sheath, a carcass arranged inside the internal sealing sheath, and around the internal sealing sheath it comprises a first tensile armor layer comprising a plurality of helically wound elongate elements having a winding angle to the center axis of about 45 degrees or less. The flexible unbonded pipe further comprises at least one high pitch outer layer of one or more elongate elements wound with an angle to the center axis of at least about 80 degrees and arranged outside the internal sealing sheath. The weight of the high pitch outer layer in at least a length section (a low pressure armor section) of the flexible unbonded pipe is about half the weight of the carcass in the section or/and the low pressure armor section has a strength relative to the strength of the carcass such that the burst pressure (BP) of the flexible unbonded pipe is about 50% or less than the maximal crushing pressure (CP) of the flexible unbonded pipe determined when the flexible unbonded pipe is lying onshore on a flat horizontal surface and allowed freely to expand/contract as a consequence of an applied pressure during the test.

### TECHNICAL FIELD

The invention relates to a flexible unbonded pipe in particular for offshore transportation of hydrocarbons and/or water as well as an offshore system comprising such flexible unbonded pipe.

### BACKGROUND ART

Unbonded flexible pipes are generally used for transporting of pressurized fluids, such as water, hydrocarbons or mixtures hereof.

As used in this text the term “unbonded” means that at least two of the layers including the armoring layers and polymer liner are not bonded to each other. The pipe layers can therefore move with respect to each other, and hereby the pipe becomes bendable, usable for dynamic applications e.g. as risers, and sufficiently flexible to roll up for transportation even when the layers are relatively thick, which is necessary for high strength pipes which should be able to withstand high pressure differences over layers of the pipe e.g. differences between the pressure inside the bore of the pipe and the pressure on the outer side of the pipe.

Recommended practices for the abovementioned flexible pipes are given in the standards API 17B (third edition) and API 17 J (second edition) published by the American Petroleum Institute, API.

According to the standard API 17B three main types of flexible pipes exist, namely the family 1-3 pipes. In table 1—corresponding to Table 1 of API 17B, the different main layers of such a pipe are given.

An unbounded pipe according to the definition above comprises two impermeable cylindrical liners, named “inner liner” and “outer sheath” in the table above. The inner liner is the primary pipe barrier confining the transported fluid, whereas the function of the outer sheath is to isolate the armor layers surrounding the inner liner from ambient water.

TABLE 1

| | Family I | Family II | Family III |
|---|---|---|---|
| Name | Smooth bore | Rough bore | Rough bore |
| | | | High pressure |
| Carcass | Absent | Yes | Yes |
| Inner liner (Internal | Yes | Yes | Yes |
| sealing sheath) | | | |
| Pressure armor | Yes | Absent | Yes |
| Tensile armor | Yes | Yes | Yes |
| Outer sheath | Yes | Yes | Yes |

To support the inner liner three armoring layers are given, these being carcass, pressure armor and tensile cross wound armor arranged along the axis of the cylindrical liners.

The function of the different armor layers is most easily explained by using family I pipes as primary example.

In a family I pipe the axial forces resulting from the combined action of tensile stress in the pipe and internal pressure are dealt with by the tensile armor which is normally wound in an angle of approx. 35° relative to the axis of the pipe. The pressure armor of a type I pipe has a dual purpose. The primary function of the pressure armor is to confine the pressure of the fluid by absorbing the radial forces which are built up during pressurization of the pipe. The pressure by which the pressure armor bursts due to internal pressures is called “burst pressure”.

An equally important function of the pressure armor is to absorb the crushing force which is a combined effect of surrounding water pressure and the squeeze from the tensile armor occurring when the pipe is pulled in the axial direction. The combined action of tensile armor and external pressure is in the following called “crush pressure”.

If a family I pipe is to be employed in deep waters it is very important that the inner liner is protected from failure by collapse due to hydrostatic pressure from the surrounding water. This failure may occur if the integrity of the outer sheath is compromised and water may flow into the armoring layers.

The traditional method to prevent collapse is to apply yet another armor layer inside the inner liner. This armor layer, dubbed “carcass” is designed to withstand the hydrostatic pressure on the inner liner if the outer sheath is breached. When a carcass is applied to a family I pipe is becomes a family III pipe.

If the pipe is to be used in less critical applications it is possible to combine the pressure armor and the tensile armor into a single layer. A less critical application could be as flow line where the only forces acting on the armor wires are due to the internal pressure in the pipe. For a flow line the armoring filaments take a winding angle close to 54.7°, as this gives the necessary doubling of strength in the circumferential direction relative to the longitudinal direction. Although API 17B specifies “around 55°” as winding angle, the correct number is 54.7°, however, small deviations of the angle of 54.7° are to be expected due to production tolerances.

Due to the critical nature of the family 1-3 pipes certain test procedure are recommended prior to use. The API recommended test procedures are listed in table 19 of API 17B. Before shipping, family 1-3 pipes are usually subjected to a factory acceptance test (FAT). The FAT comprises at least pressurization of the pipe to x*(maximum operational pressure) 1.2>x>1.6. The maximum operational pressure will normally be estimated by the purchaser of the pipe. FAT can be used to verify the structural integrity of the pipe as well as the integrity of the end terminations of the pipe. Although the pipes are coiled on a turntable during a FAT test, and thus not subjected to operational conditions, experience has nevertheless shown that FAT in most situations will reveal any serious defects in the tested pipes.

In recent years oil and gas are extracted from increasingly deep waters, hence the demands for a robust crushing armor for type III pipes are steadily increasing. This is especially true for pipes used for fluid communication between the sea floor and the sea surface, so called “risers”.

In particular, when used for very deep waters >1500 m the risers are subjected to very high crushing loads, partly due to the extreme squeezing forces near the top-end of the riser and partly due to the extreme hydrostatic forces in deep water.

In the art numerous solutions are suggested for coping with the extreme external pressures. U.S. Pat. No. 6,415,825 teaches a solution where the strength of the pressure armoring layer is increased dramatically by applying an additional wound layer on top of a conventional pressure armoring layer. By thus increasing the collapse strength of the pressure armor, the pipe resistance towards external pressure as well as squeeze is greatly increased.

The strengthening solution according to U.S. Pat. No. 6,415,825 will result in an excessively heavy pipe, hereby resulting in a very high hang-off weight of the pipe which may render the principle unusable for oil exploration at great water depths.

An interesting alternative to global strengthening of the entire pipe is presented in US 640176. According to the teachings in this patent the strength of a pipe can be varied along the axis of the pipe. Thus, strength and associated weight can be applied only where needed. Although variations of the armor along the axis may to some extent solve the weight issues of the pipe, there is still a need for improved solutions.

### DISCLOSURE OF INVENTION

It is the object of this invention to provide a flexible unbonded pipe which is capable of handling extreme crushing loads while simultaneously having a relatively low weight compared to prior art high strength flexible unbonded pipes.

Furthermore it is the object to provide a flexible unbonded pipe with a high strength which can be used for transporting fluids offshore at high pressure while simultaneously being relatively simple and inexpensive to produce.

These objects have been achieved by the flexible unbonded pipe as defined in the claims. Preferred embodiments of the invention are defined in the depending claims and/or described in the following.

As it will be clear from the following descriptions the invention opens up for providing a large variety of embodiments with improved and additional beneficial properties.

The flexible pipe invention also form basis for the offshore system of the invention and the improved and additional beneficial properties obtained by offshore system in general and of embodiments thereof.

The flexible unbonded pipe of the invention provides a whole new family of flexible pipes which have hitherto never been considered. In particular it has never been considered to provide a pipe with non-balanced tensile armoring and a highly reduced or completely absent pressure armor.

Hitherto it has been standard that a flexible unbonded pipe should pass a hydrostatic pressure test of an internal pressure of 1.5 times design pressure, as described in API 17J (second edition). The flexible unbonded pipe of the invention will not be able to pass this test for most applications where the design pressure is relatively high—e.g. for use in deep water offshore systems, but according to the invention it has been found that flexible unbonded pipe constructed in line with the requirements of the invention can be sufficiently strong for such applications.

In the following the term “length of the pipe” is used to mean the length along the axis of the pipe and the length along which a fluid can flow in the bore of the pipe. The space inside the inner sealing sheath is referred to as the bore of the pipe.

The terms “axial direction” or “axially” are used to mean the direction along the length of an axis of the pipe. Generally it is desired that the flexible pipe is substantially circular in cross sectional shape, however, it should be understood the flexible pipes could have other cross sectional shapes such an oval, elliptical or slightly angular (angular with rounded edges) shape. The axis of the flexible pipes may in such situations be determined as the most central axis in the bore of the flexible pipe. The terms “outside” and “inside” a member and/or a layer are used to mean “outside, respectively inside said member and/or a layer in radial direction from, and perpendicular to the axis of the pipe and radially out towards an outermost surface of the pipe respectively in radial direction from, and perpendicular to the outermost surface of the pipe and radially towards the axis of the pipe”.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The flexible unbonded pipe of the invention has a center axis extending along the length of the pipe. Usually the flexible unbonded pipe will be substantially circular in cross section, but it may have other cross sectional shapes, e.g. as described above. The center axis is determined as an axis lying as centrally as possible along the length of the pipe.

The flexible unbonded pipe comprises an internal sealing sheath surrounding the center axis. The internal sealing sheath defines the bore of the flexible unbonded pipe in which a liquid can be transferred. The purpose of the internal sealing sheath is to provide a sealing against outflow of a fluid transported in the flexible unbonded pipe, although, as it is well known, small amounts of fluids, e.g. gasses may pass through the internal sealing sheath.

The flexible unbonded pipe further comprises a carcass arranged inside the internal sealing sheath, and around the internal sealing sheath it comprises a first tensile armor layer comprising a plurality of helically wound elongate elements with a winding angle to the center axis of about 45 degrees or less. The flexible unbonded pipe additionally comprises at least one high pitch outer layer of one or more elongate elements wound with an angle to the center axis of at least about 80 degrees. The at least one high pitch outer layer is arranged outside the internal sealing sheath.

In a first characteristic aspect of the invention the weight of the high pitch outer layer in at least a length section of the flexible unbonded pipe designated a low pressure armor section is about half the weight of the carcass in the low pressure armor section or less.

In a second characteristic aspect of the invention which optionally may be combined with the first characteristic aspect of the invention, the high pitch outer layer in at least a length section of the flexible unbonded pipe designated a low pressure armor section has a strength relative to the strength of the carcass such that the burst pressure (BP) of the flexible unbonded pipe is about 50% or less than the crush pressure (CP) of the flexible unbonded pipe determined when the flexible unbonded pipe is lying onshore on a flat horizontal surface and allowed freely to expand/contract as a consequence of an applied pressure during the test.

The terms “collapse pressure” and “crush pressure” are used interchangeably.

A length section of the flexible unbonded pipe, such as a low pressure armor section of the flexible unbonded pipe is herein used to designate a section between two distinct cross sectional planes perpendicular to the center axis of the flexible unbonded pipe determined when the flexible unbonded pipe is held straight. The low pressure armor section of the flexible unbonded pipe has a length corresponding to the distance between the distinct cross sectional planes when the flexible unbonded pipe is lying straight on a flat horizontal surface and in un-pressurized and un-tensioned state i.e. the flexible unbonded pipe is not subjected to any forces beyond gravity and atmospheric pressure inside and outside the flexible unbonded pipe. The low pressure armor section of the flexible unbonded pipe may preferably be at least about 5 m, such as at least about 10 m, such as at least about 25 m, such as at least about 50 m.

The term “a low pressure armor section” is used to designate a section of the flexible unbonded pipe which has the first and/or the second characteristic aspect of the invention. The word “low” in the term “a low pressure armor section” is merely a part of the name of the low pressure armor section and should not be used to interpret any level of strength of the flexible unbonded pipe in full or part of its length.

Usually the low pressure armor section is from about 5 m to the whole length of the flexible unbonded pipe, such as at least about 1% of the length of the flexible unbonded pipe, such as at least about 5% of the length of the flexible unbonded pipe, such as at least about 10% of the length of the flexible unbonded pipe, such as at least about 15% of the length of the flexible unbonded pipe, such as at least about 20% of the length of the flexible unbonded pipe, such as up to about 99% of the length of the flexible unbonded pipe, such as up to about 95% of the length of the flexible unbonded pipe, such as up to about 90% of the length of the flexible unbonded pipe, such as up to about 80% of the length of the flexible unbonded pipe.

The BP (burst pressure) is the maximal pressure possible in the bore minus pressure acting on the pipe towards the center axis (usually about 100 kPa). The CP (crush pressure) is the maximal pressure possible outside the flexible unbonded pipe minus the pressure inside the flexible unbonded pipe (usually about 100 kPa).

Due to a reduced weight of the outer armoring and in particular a lower weight of pressure armor of the flexible unbonded pipe, the total weight of the flexible unbonded pipe can be highly reduced, which both results in a reduced cost in production, reduced cost in transportation and in reduced tensile forces applied to the flexible unbonded pipe during laying out (deployment) and/or when used as a riser. In particular the reduced tensile forces applied to the flexible unbonded pipe during deployment and/or when used as a riser are very important since such tensile forces applied to the flexible unbonded pipe during deployment and/or when used as a riser can be very considerable and may even result in rupturing of the pipe. When the flexible unbonded pipe is to be used at deep waters—e.g. deeper than 2000 m or even 2500 m, very high tensile forces will be applied to a prior art flexible unbonded pipe during deployment and/or when used as a riser and this may require that the flexible unbonded pipe is provided with additional tensile armor layers. In the flexible unbonded pipe the tensile forces applied during deployment and/or when used as a riser will be reduced compared to when using a prior art flexible unbonded pipe.

The BP and CP tests are performed according to ordinary standard for prototypes as specified in API 17B (burst test/collapse test).

According to the invention it has been found that when the flexible unbonded pipe of the invention is deployed and/or when used as a riser, the tensile forces applied to the flexible unbonded pipe result in a squeezing pressure applied via the tensile armor layer(s) to the internal sealing sheath. This squeezing pressure has shown to be sufficient to compensate for the reduced or absent pressure forces which in prior art flexible unbonded pipes are provided by the outer pressure armor layers.

The terms “armor layer” and “armoring layer” are used interchangeably.

Therefore, in the present invention the flexible unbonded pipe is constructed such that the tensile forces applied to the flexible unbonded pipe during deployment and/or when used as a riser are both reduced and are simultaneously utilized for a secondary purpose, namely to compensate for pressure forces necessary for the flexible unbonded pipe to avoid burst in use.

In one embodiment of the flexible unbonded pipe, the at least one high pitch outer layer in at least the low pressure armor section of the flexible unbonded pipe has a strength relative to the strength of the carcass such that the burst pressure of the flexible unbonded pipe is about 45% or less than the crushing pressure of the flexible unbonded pipe. The burst pressure is for example about 40% or less, such as about 35% or less, such as about 30% or less, such as about 25% or less than the crushing pressure of the flexible unbonded pipe.

In practice it can be said that the deeper the water is into which the flexible unbonded pipe is to be deployed and/or used as a riser, the lower the BP/CP value can be. Based on the teaching herein the skilled person will be able to calculate a desired and/or optimal BP/CP value for a specific flexible unbonded pipe of the invention for a specific application.

In one embodiment the at least one high pitch outer layer in at least the low pressure armor section of the flexible unbonded pipe has a strength so that the burst pressure of the flexible unbonded pipe is up to about 20,000 kPa bars, such as up to about 15,000 kPa, such as up to about 10,000 kPa, such as up to about 5,000 kPa, such as up to about 1,000 kPa, such as up to about 500 kPa.

In one embodiment the weight of the high pitch outer layer in at least the low pressure armor section of the flexible unbonded pipe is about 45% or less, such as about 40% or less, such as 35% or less, such as 30% or less, such as 25% or less of the weight of the carcass in the low pressure armor section.

As explained above, the relatively low weight of the high pitch outer layer(s) of the flexible unbonded pipe of the invention compared to the outer pressure armor layer(s) of prior art flexible unbonded pipe is highly beneficial. For certain embodiments of the invention the weight of the high pitch outer layer in the low pressure armor section of the flexible unbonded pipe may be even substantially less than 25% of the weight of the carcass, e.g. as low as 5-15% of the weight of the carcass.

The purpose of the high pitch outer layer(s) is not necessarily to provide the flexible unbonded pipe with pressure strength, but may in one embodiment merely be to provide a support for the application of squeezing pressure applied via the tensile armor layer(s) to the internal sealing sheath when the flexible unbonded pipe is in use, while simultaneously ensuring that the internal sealing sheath is not damaged by creeping into interstices of the elongate elements of the tensile armor layer(s).

The flexible unbonded pipe may comprise one or more high pitch outer layers. In one embodiment the flexible unbonded pipe comprises only one high pitch outer layer in the low pressure armor section. This high pitch outer layer may preferably be interlocked in order to avoid creep of adjacent polymer layer(s) into interstices of the elongate elements of the tensile armor layer.

In one embodiment the flexible unbonded pipe comprises two or more high pitch outer layers in the low pressure armor section, and preferably at least one of the high pitch outer layers, such as the innermost high pitch outer layer is interlocked.

In one embodiment the weight of the high pitch outer layers in total in the low pressure armor section of the flexible unbonded pipe is about 50% or less, such as about 45% or less, such as about 40% or less, such as 35% or less, such as 30% or less, such as 25% or less of the weight of the carcass in the low pressure armor section.

In one embodiment the high pitch outer layer or the high pitch outer layers together in at least the low pressure armor section of the flexible unbonded pipe have a maximal thickness which is less than half of the maximal thickness of the carcass.

The maximal thickness is determined as the thickness in radial direction from the point of the layer in question closer to the axis of the pipe to the point of the layer in question more remote from the axis in a cross-section of the flexible unbonded pipe. The total thickness of the high pitch outer layers together is the sum of the maximal thickness of the high pitch outer layers.

In one embodiment the flexible unbonded pipe comprises at least one high pitch outer layer arranged between the internal sealing sheath and the first tensile armor layer, this high pitch outer layer is preferably interlocked in order to reduce or avoid creeping of the internal sealing sheath into interstices of the elongate elements of the tensile armor layer.

In one embodiment the high pitch outer layer arranged between the internal sealing sheath and the first tensile armor layer provides an anti-creep layer to substantially prevent the internal sealing sheath from creeping into interstices between elongate elements of the first tensile armor layer.

To ensure a high anti-creep effect of the anti-creep layer it is desired that the anti-creep layer is of a material with a relatively high stability against deformation, such as a metal and/or a reinforced polymer material, e.g. a polymer compound with reinforcement fibers comprising glass-fibers, carbon-fibers, aramide fibers and/or a mixture thereof.

In one embodiment the anti-creep layer is of a material having a yield strength of at least about 50 MPa, preferably at least about 100 MPa.

The elongate element(s) of the anti-creep layer may in principle have any shape or profile. In one embodiment the elongate element(s) of the anti-creep layer is or comprises a wire having a cross-sectional profile selected from a round profile, an angular profile, C-shaped profile, a U-shaped profile, a T-shaped profile, an I-shaped profile, a K-shaped profile, a Z-shaped profile, an X-shaped profile, a ψ (psi)-shaped profile and combinations thereof.

In one embodiment the elongate element(s) of the anti-creep layer is or comprises a folded strip having a cross-sectional profile along its annular extent comprising one or more folds, preferably selected from an S-shape folded profile, a C-shaped folded profile, a Q-shape folded profile, an O-shaped folded profile, and combinations thereof.

In a desired embodiment the high pitch outer layer providing the anti-creep layer comprises interlocked C-shaped clips. This anti-creep layer generally provides a high anti-creep effect.

In one embodiment the flexible unbonded pipe comprises at least one high pitch outer layer arranged between the first and the second tensile armor layers.

In one embodiment the flexible unbonded pipe comprises at least one high pitch outer layer arranged on the outer side of the second tensile armor layer, preferably in the form of a non-metallic layer, such as fibre reinforced polymeric tapes.

The high pitch outer layer(s) applied outside the tensile armor layer(s) provides a good support to the underlying tensile layer to avoid or reduce the risk of birdcaging of the elongate elements of the tensile armor layer and/or to avoid or reduce the risk of upheaval buckling.

In one embodiment the one or more one high pitch outer layers comprise interlocked or non-interlocked elongate element(s), such as wire(s) and/or strip(s) made from a metal, such as steel, aluminium or titanium and/or made from extruded tapes comprising reinforcing fibres such as fibers of glass, carbon and/or aramide or made from a polymer having a yield strength of at least about 50 MPa and/or a tensile strength of at least about 100 MPa.

The carcass of the flexible unbonded pipe according to the invention comprises a multitude of annular armoring members, such as ring shaped elements and/or one or more helically wound structures with a relatively high winding angle to the pipe axis e.g. about 80 degrees or more. Examples of wires/strips and the cross-sectional profiles thereof which can be applied in the carcass of the flexible unbonded pipe of the invention are e.g. as described in any one of U.S. Pat. No. 5,176,179, U.S. Pat. No. 5,813,439, U.S. Pat. No. 3,311,133, U.S. Pat. No. 3,687,169, U.S. Pat. No. 3,858,616, U.S. Pat. No. 4,549,581, U.S. Pat. No. 4,706,713, U.S. Pat. No. 5,213,637, U.S. Pat. No. 5,407,744, U.S. Pat. No. 5,601,893, U.S. Pat. No. 5,645,109, U.S. Pat. No. 5,669,420, U.S. Pat. No. 5,730,188, U.S. Pat. No. 5,730,188, U.S. Pat. No. 5,813,439, U.S. Pat. No. 5,837,083, U.S. Pat. No. 5,922,149, U.S. Pat. No. 6,016,847, U.S. Pat. No. 6,065,501, U.S. Pat. No. 6,145,546, U.S. Pat. No. 6,192,941, U.S. Pat. No. 6,253,793, U.S. Pat. No. 6,283,161, U.S. Pat. No. 6,291,079, U.S. Pat. No. 6,354,333, U.S. Pat. No. 6,382,681, U.S. Pat. No. 6,390,141, U.S. Pat. No. 6,408,891, U.S. Pat. No. 6,415,825, U.S. Pat. No. 6,454,897, U.S. Pat. No. 6,516,833, U.S. Pat. No. 6,668,867, U.S. Pat. No. 6,691,743, U.S. Pat. No. 6,739,355 U.S. Pat. No. 6,840,286, U.S. Pat. No. 6,889,717, U.S. Pat. No. 6,889,718, U.S. Pat. No. 6,904,939, U.S. Pat. No. 6,978,806, U.S. Pat. No. 6,981,526, U.S. Pat. No. 7,032,623, U.S. Pat. No. 7,311,123, U.S. Pat. No. 7,487,803, US 23102044, WO 28025893, WO 2009024156, WO 2008077410 and WO 2008077409.

The examples of structures/shapes of wires/strips and the cross-sectional profiles thereof can also be applied in other wound layers, e.g. tensile layer(s) and high pitch outer layer(s).

In one embodiment the carcass comprises one or more helically wound elongate element, the elongate element(s) preferably comprises at least one wire, and/or at least one folded strip, the one or more elongate elements optionally being interlocked with itself or each other in consecutive windings thereof.

In one embodiment the carcass comprises or consists of a high pitch inner layer inside the internal sealing sheath comprising one or more wound elongate elements wound with an angle to the center axis of at least 80 degrees, such as of at least 85 degrees.

In one embodiment the carcass comprises a plurality of annular armoring members arranged along the length of the flexible pipe, the annular armoring members preferably being ring-shaped armoring members which may comprise endless ring-shaped armoring members and/or open ring-shaped armoring members. Such annular armoring members are e.g. described in DK PA 2009 01163.

In one embodiment the plurality of annular armoring members comprise at least a ring-shaped armoring member, in the form of an endless ring-shaped armoring member or an open ring-shaped armoring member.

In one embodiment the plurality of annular armoring members arranged along the length of the flexible pipe are substantially identical with each other.

In one embodiment the plurality of annular armoring members arranged along the length of the flexible pipe comprise at least two different annular armoring members, the annular armoring members preferably differing from each other with respect to one or more of their

annular shape;
cross-sectional profile;
axial width;
thickness;
stiffness;
material or materials;
mechanical strength;
chemical resistance, in particular towards aggressive gasses such as methane, hydrogen sulphides and/or carbon dioxides; and
corrosion resistance.

In one embodiment the plurality of annular armoring members are engaged with each other, preferably the carcass comprises at least one engagement member, the at least one engagement member being an annular engagement member or a non-annular engagement member arranged to engage with at least two annular armoring members, the at least one engagement member preferably being a clip.

Further information about annular armoring members which may be used as one or more of the strength imparting layers can be found in DK PA 2009 01163.

In one embodiment at least one elongate element and/or at least one of the annular armoring members of the carcass is a wire having a cross-sectional profile selected from a round profile, an angular profile, C-shaped profile, a U-shaped profile, a T-shaped profile, an I-shaped profile, a K-shaped profile, a Z-shaped profile, an X-shaped profile, a Iv (psi)-shaped profile and combinations thereof.

In one embodiment at least one elongate element and/or at least one of the annular armoring members of the carcass is a folded strip having a cross-sectional profile along its annular extent comprising one or more folds, preferably selected from an S-shape folded profile, a C-shaped folded profile, a Q-shape folded profile, an O-shape folded profile, and combinations thereof.

In one embodiment the carcass comprises or is made from one or more materials, preferably selected from metal, such as aluminum, titanium, steel e.g. duplex steel, stainless steel and carbon steel, and fiber armed polymers, such as from polyolefins, e.g. polyethylene (e.g. cross linked—PEX) and poly propylene; polyamide, e.g. poly amide-imide, polyamide-11 (PA-11), polyamide-12 (PA-12) and polyamide-6 (PA-6)); polyimide (PI); polyurethanes; polyureas; polyesters; polyacetals; polyethers, e.g. polyether sulphone (PES); polyoxides; polysulfides, e.g. polyphenylene sulphide (PPS); polysulphones, e.g. polyarylsulphone (PAS); polyacrylates; polyethylene terephthalate (PET); polyether-ether-ketones (PEEK); polyvinyls; polyacrylonitrils; polyetherketoneketone (PEKK); copolymers of the preceding; fluorous polymers e.g. polyvinylidene diflouride (PVDF), homopolymers or copolymers of vinylidene fluoride (“VF2”), homopolymers and copolymers of trifluoroethylene (“VF3”), copolymers or terpolymers comprising two or more different members selected from VF2, VF3, chlorotrifluoroethylene, tetrafluoroethylene, hexafluoropropene, and hexafluoroethylene; compounds comprising one or more of the above mentioned polymers, and/or composite materials, such as a polymer (e.g. one of the above mentioned) compounded with reinforcement fibers, such as glass-fibers, carbon-fibers and/or aramide fibers.

Useful metal compositions for the carcass which may be used separately or in any combinations comprise the steel material described in U.S. Pat. No. 5,407,744, the steel material described in U.S. Pat. No. 5,922,149, the steel material described in U.S. Pat. No. 6,291,079, the steel material described in U.S. Pat. No. 6,408,891, the steel material described in U.S. Pat. No. 6,904,939, the steel material described in U.S. Pat. No. 7,459,033, the steel material described in WO 06097112, the steel material described in U.S. Pat. No. 6,282,933 and the steel material described in U.S. Pat. No. 6,408,891.

In one embodiment the carcass is made from or comprises a composite material comprising one or more polymers selected from thermoset polymers, cross-linked polymers and/or reinforced polymer, the reinforcement polymer preferably being reinforced with one or more of metals, such as metal powder and/or metal fibers; glass-fibers; carbon-fibers and/or aramide fibers. Preferred composite materials which may be used separately or in any combinations comprise the composite material described in U.S. Pat. No. 4,706,713, the composite material materials described in WO 05043020 and the composite materials described in WO 02095281.

In one embodiment the carcass comprises or is made from polymers, with or without fiber reinforcement and having a yield strength of at least about 50 MPa, preferably at least about 100 MPa and/or metal.

In one embodiment the carcass has a maximum thickness of at least about 1 mm, such as at least about 2 mm, such as at least about 4 mm, such as at least about 6 mm, such as up to about 20 mm, such as up to about 15 mm, such as up to about 12 mm.

The structure, material and thickness of the carcass are selected in relation to the requirement of the flexible unbonded pipe, and in particular in relation to the design crush pressure.

In order to avoid or reduce creep of the internal sealing sheath into interstices in the carcass a liquid pervious inner anti-creep layer may be arranged between the carcass and the internal sealing sheath. The liquid pervious inner anti-creep layer may for example be a wound or folded film or foil, such as a metal foil.

The internal sealing sheath may in practice be as any prior art internal sealing sheaths. The internal sealing sheath may e.g. have a thickness of about 4 mm or more, such as about 6 mm or more, such as about 8 mm or more, such as about 10 mm or more.

In one embodiment the internal sealing sheath comprises one or more of the materials selected from polyolefins, e.g. polyethylene (e.g. cross linked—PEX) and poly propylene; polyamide, e.g. poly amide-imide, polyamide-11 (PA-11), polyamide-12 (PA-12) and polyamide-6 (PA-6)); polyimide (PI); polyurethanes; polyureas; polyesters; polyacetals; polyethers, e.g. polyether sulphone (PES); polyoxides; polysulfides, e.g. polyphenylene sulphide (PPS); polysulphones, e.g. polyarylsulphone (PAS); polyacrylates; polyethylene terephthalate (PET); polyether-ether-ketones (PEEK); polyvinyls; polyacrylonitrils; polyetherketoneketone (PEKK); copolymers of the preceding; fluorous polymers e.g. polyvinylidene diflouride (PVDF), homopolymers or copolymers of vinylidene fluoride (“VF2”), homopolymers and copolymers of trifluoroethylene (“VF3”), copolymers or terpolymers comprising two or more different members selected from VF2, VF3, chlorotrifluoroethylene, tetrafluoroethylene, hexafluoropropene, and hexafluoroethylene; compounds comprising one or more of the above mentioned polymers, and/or composite materials, such as a polymer (e.g. one of the above mentioned) compounded with reinforcement fibers, such as glass-fibers, carbon-fibers and/or aramide fibers.

In one embodiment the elongate elements of the first tensile armor layer are wound in an angle to the center axis which is about 40 degrees or less, such as about 35 degrees or less, such as about 30 degrees or less, such as between about 20 degrees and 45 degrees.

Preferably the flexible unbonded pipe comprises a second tensile armor layer comprising a plurality of helically wound elongate elements which are cross wound with respect to the elongate elements of the first tensile armor layer and having a winding angle to the center axis which is different or equal to the corresponding angle of the elongate elements of the first tensile armor layer, the angle of the elongate elements of the second tensile armor layer is preferably about 45 degrees or less.

The elongate elements of the tensile armor layer(s) may in principle be of any material or combination of materials which is/are sufficiently strong to withstand the tensile force applied to the elongate element when the flexible unbonded pipe is in use.

In one embodiment the elongate elements of the first and the second tensile armor layers independently of each other comprise one or more of the materials steel, aluminium, titanium carbon fibres, glass fibres, aramide fibres, polyethylene fibres, ropes comprising such fibers optionally with metal reinforcement, pultruded elements comprising such fibers, composite material comprising such fibers, e.g. composite element comprising thermoplastic and/or thermoset polymers, for example one or more of epoxy from polyolefins, e.g. polyethylene (e.g. cross linked—PEX) and poly propylene; polyamide, e.g. poly amide-imide, polyamide-11 (PA-11), polyamide-12 (PA-12) and polyamide-6 (PA-6)); polyimide (PI); polyurethanes; polyureas; polyesters; polyacetals; polyethers, e.g. polyether sulphone (PES); polyoxides; polysulfides, e.g. polyphenylene sulphide (PPS); polysulphones, e.g. polyarylsulphone (PAS); polyacrylates; polyethylene terephthalate (PET); polyether-ether-ketones (PEEK); polyvinyls; polyacrylonitrils; polyetherketoneketone (PEKK); copolymers of the preceding; fluorous polymers e.g. polyvinylidene diflouride (PVDF), homopolymers or copolymers of vinylidene fluoride (“VF2”), homopolymers and copolymers of trifluoroethylene (“VF3”), copolymers or terpolymers comprising two or more different members selected from VF2, VF3, chlorotrifluoroethylene, tetrafluoroethylene, hexafluoropropene, and hexafluoroethylene.

The elongate elements of the tensile armor layer(s) may for example be of the materials described above for the carcass.

In one embodiment the elongate elements of the first and the second tensile armor layers independently of each other are in the form of tapes, folded strips, wires and/or, ropes.

In one embodiment at least one of the elongate elements of the first and the second tensile armor layers is a wire having a cross-sectional profile selected from a round profile, an angular profile, C-shaped profile, a U-shaped profile, a T-shaped profile, an I-shaped profile, a K-shaped profile, a Z-shaped profile, an X-shaped profile, a ψ (psi)-shaped profile and combinations thereof.

In one embodiment at least one of the elongate elements of the first and the second tensile armor layers is a folded strip having a cross-sectional profile along its annular extent comprising one or more folds, preferably selected from an S-shape folded profile, a C shaped folded profile, a Q-shape folded profile, an O-shape folded profile, and combinations thereof.

In one embodiment at least one of the first and the second tensile armor layers comprises elongate elements of steel having a yield strength of at least about 500 MPa, such as at least about 600 MPa, such as at least about 650 MPa, such as at least about 700 MPa, such as at least about 750 MPa, such as at least about 800 MPa, such as at least about 1000 MPa.

In one embodiment at least one of the first and the second tensile armor layers comprises elongate elements comprising a polymer reinforced with at least one of carbon fibres or/and glass fibres, the polymer preferably comprises a thermoset polymer.

In one embodiment at least one of the first and the second tensile armor layers comprises elongate elements comprising a plurality of strength imparting layers bonded to each other with a thermoplastic polymer or a polymer that has been cross-linked after winding to form the tensile armor layer, the strength imparting layers preferably are of metal and/or fiber reinforced polymer, such as epoxy.

An example of elongate elements comprising a plurality of strength imparting layers bonded to each other with a thermoplastic polymer is e.g. the elongate elements described in WO02095281.

In one embodiment a plurality of the elongate elements of the first tensile armor layer are in the form of tapes, folded strips, and/or wires of steel, optionally the first tensile armor layer is in the form of elongate elements of steel with in between elongate elements of an elastic material, such as rubber.

In one embodiment the plurality of the elongate elements of the second tensile armor layer comprise a plurality of strength imparting layers bonded to each other with a thermoplastic polymer or a polymer that has been cross-linked after winding to form the tensile second armor layer, the strength imparting layers preferably are of fiber reinforced polymer, such as epoxy, the strength imparting layers preferably are of carbon fiber reinforced polymer (CFRP).

In one embodiment a tensile armor intermediate layer is applied between the first and the second tensile armor layers, the tensile armor intermediate layer is an anti-wear layer and/or a galvanic barrier layer and/or a thermal insulating layer.

If the tensile armor intermediate layer is a liquid pervious anti-wear layer it may preferably be of a thermoplastic material, having a thickness of about 10 mm or less, such as about 5 mm or less, such as about 1 mm or less.

In one embodiment the tensile armor intermediate layer is a liquid impervious galvanic barrier layer preventing galvanic reaction between the first and the second tensile armor layers.

By having such a liquid impervious galvanic barrier layer the freedom of selecting the material(s) for the respective tensile armor layer is highly increased, since the liquid impervious galvanic barrier layer will reduce or even prevent galvanic reactions caused by difference of the materials.

For example a carbon fiber reinforced polymer (CFRP) can be applied in one of the tensile armor layers and steel can be applied in the other tensile armor layer without this resulting in corrosion of the steel. When using CFRP in the flexible unbonded pipe it is generally desired that the CFRP should be electrically insulated from the steel parts in order to avoid corrosion of the steel.

The galvanic barrier layer may e.g. be an extruded layer of a polymer material, having a thickness of about 1 mm or more, such as about 2 mm or more such as about 5 mm or more.

In one embodiment the tensile armor intermediate layer is a thermal insulating layer of a polymer material, having a thickness of about 1 mm or more, such as about 2 mm or more, such as 10 mm or more the thermal insulating layer may be folded, wound or extruded.

In one embodiment, the flexible unbonded pipe comprises more than two tensile armor layers, such as 3 layers, 4 layers or 6 layers.

In one embodiment the flexible unbonded pipe comprises at least one outer protecting sheath, located outside the tensile armor layers, the outer liquid impervious sheath may be liquid impervious or liquid pervious and may preferably comprise one or more of the materials polyolefins, e.g. polyethylene optionally cross linked (PEX) and poly propylene; polyamide, e.g. poly amide-imide, polyamide-11 (PA-11), polyamide-12 (PA-12) and polyamide-6 (PA-6)); polyimide (PI); polyurethanes and polyureas.

Outer protecting sheaths of flexible unbonded pipes are well known, and in principle the outer protecting sheath may be as any outer protecting sheath of prior art pipes.

Provided that the flexible unbonded pipe of the invention maintains the first and/or the second characteristic aspect of the invention, the flexible unbonded pipe of the invention may accordingly be combined with any additional layers selected from the layers of flexible pipes described in any one of the prior art documents GB 1 404 394, U.S. Pat. No. 3,311,133, U.S. Pat. No. 3,687,169, U.S. Pat. No. 3,858,616, U.S. Pat. No. 4,549,581, U.S. Pat. No. 4,706,713, U.S. Pat. No. 5,213,637, U.S. Pat. No. 5,407,744, U.S. Pat. No. 5,601,893, U.S. Pat. No. 5,645,109, U.S. Pat. No. 5,669,420, U.S. Pat. No. 5,730,188, U.S. Pat. No. 5,730,188, U.S. Pat. No. 5,813,439, U.S. Pat. No. 5,837,083, U.S. Pat. No. 5,922,149, U.S. Pat. No. 6,016,847, U.S. Pat. No. 6,065,501, U.S. Pat. No. 6,145,546, U.S. Pat. No. 6,192,941, U.S. Pat. No. 6,253,793, U.S. Pat. No. 6,283,161, U.S. Pat. No. 6,291,079, U.S. Pat. No. 6,354,333, U.S. Pat. No. 6,382,681, U.S. Pat. No. 6,390,141, U.S. Pat. No. 6,408,891, U.S. Pat. No. 6,415,825, U.S. Pat. No. 6,454,897, U.S. Pat. No. 6,516,833, U.S. Pat. No. 6,668,867, U.S. Pat. No. 6,691,743, U.S. Pat. No. 6,739,355 U.S. Pat. No. 6,840,286, U.S. Pat. No. 6,889,717, U.S. Pat. No. 6,889,718, U.S. Pat. No. 6,904,939, U.S. Pat. No. 6,978,806, U.S. Pat. No. 6,981,526, U.S. Pat. No. 7,032,623, U.S. Pat. No. 7,311,123, U.S. Pat. No. 7,487,803, US 23102044, WO 28025893, WO 2009024156, WO 2008077410 and WO 2008077409.

In one embodiment the flexible unbonded pipe comprises a thermal insulation comprising one or more wound, folded and/or extruded layers of polymer.

In one embodiment the flexible unbonded pipe has a pipe length along its center axis, at least one of the layers of the flexible unbonded pipe varies continuously or step wise along at least a part of the pipe length with respect to one or more of their

material type and/or composition;
thickness and/or weight;
crushing and/or compression strength;
chemical resistance, such as resistance towards aggressive gasses, such as methane, hydrogen sulphides and/or carbon dioxides; and
corrosion resistance.

In one embodiment of the flexible unbonded pipe, at least one high pitch outer layer of the flexible unbonded pipe varies continuously or step wise along at least a part of the pipe length with respect to one or more of its

material type and/or composition;
thickness and/or weight;
crushing and/or compression strength;
chemical resistance, such as resistance towards aggressive gasses, such as methane, hydrogen sulphides and/or carbon dioxides; and
corrosion resistance.

The flexible unbonded pipe may have any length, but preferably the flexible unbonded pipe has a pipe length of at least about 500 m, such as at least about 1000 m, such as at least about 2000 m, such as at least about 2500 m.

In one embodiment the flexible unbonded pipe is a flow line.

In one embodiment the flexible unbonded pipe is a riser.

The flexible unbonded pipe may further comprise one or more sensors, e.g. at least one optical sensor for example as described in any one of U.S. Pat. No. 7,024,941, WO 2008077410, WO 2009106078 and DK PA 2009 01086.

In one embodiment the flexible unbonded pipe comprises at least one optical fiber sensor, preferably the flexible unbonded pipe comprises at least one optical fiber sensor arranged between the internal sealing sheath and the first tensile armor layer.

The offshore system comprises at least one flexible unbonded pipe of the invention as described above. The offshore system may comprise two or more flexible unbonded pipes wherein at least one of them is according to the invention. The offshore system is accordingly a system comprising a flexible unbonded pipe of the invention as described above in deployed condition wherein at least one low pressure armor section preferably is applied below sea surface.

The offshore system may comprise any additional elements, such as elements which are usually part of an offshore system for example one or more of an umbilical, an end fitting, a clamp, an anchoring element, a tensioner, a bend restrictor, a support structure, a buoyancy module and other elements such as the elements of flexible pipe systems disclosed in at least one of API 17B (third edition) and API 17J (second edition).

In one embodiment of the offshore system of the invention, the flexible unbonded pipe is fixed in a first and a second end on either side of the low pressure armor section, such that a tensile force in a direction substantially parallel to the center axis acts on the low pressure armor section of the pipe when the pressure in the bore exceeds the hydrostatic pressure applied on an outer side of the flexible unbonded pipe.

The term “substantially parallel” should in this connection be construed to mean that the direction of the tensile forces in general follows the same direction as the center axis of the pipe, also if the pipe is more or less bent.

In one embodiment of the offshore system of the invention, at least the low pressure armor section of the flow line is applied with its center axis mainly in substantially horizontal direction. This will usually be the case where the flexible unbonded pipe comprising the low pressure armor section is a flow line. In order to trigger a squeezing pressure of the tensile armor layer(s), the flow line may be fixed at either side of the low pressure armor section, such that the low pressure armor section cannot contract in length, but instead a tensile force is built up as the pressure inside the pipe is increased. In a variation thereof or additionally a tensile force may be applied to the flexible unbonded pipe.

In one embodiment of the offshore system of the invention, the flexible unbonded pipe is a riser having an uppermost end and a lowermost end. Preferably the riser comprises at least a low pressure armor section arranged such that a tensile force in a direction substantially parallel to the center axis acts on the low pressure armor section of the riser due to the weight of at least a part of the riser.

In one embodiment, the riser comprises a least a low pressure armor section arranged such that a tensile force in a direction substantially parallel to the center axis acts on the low pressure armor section of the riser due to an applied pulling force with a direction substantially parallel to the center axis.

The applied pulling may e.g. be in form of a weight module.

In one embodiment of the offshore system of the invention, the riser comprises at least a low pressure armor section within an uppermost part of the riser extending from the uppermost end to about 99% of the length of the riser, such as to about 99% of the length of the riser, such as to about 90% of the length of the riser, such as to about 80% of the length of the riser, such as to about 70% of the length of the riser, such as to about 60% of the length of the riser, such as to about 50% of the length of the riser, such as to about 40% of the length of the riser, such as to about 30% of the length of the riser, such as to about 20% of the length of the riser, such as to about 10% of the length of the riser.

In one embodiment of the offshore system of the invention, the major part of the length of the riser, such as the whole riser, constitutes a low pressure armor section.

In one embodiment of the offshore system of the invention, at least the low pressure armor section of the riser is applied with its center axis mainly in substantially vertical direction.

The tensile force in a direction substantially parallel to the center axis directly or indirectly provides a squeezing pressure on the internal sealing sheath. In one embodiment the squeezing pressure is sufficiently high to increase the absolute burst pressure ABP in the low pressure armor section with at least about 10%, such as at least about 25%, such as at least about 50%, such as at least about 75%, such as at least about 100%, such as at least about 150%, such as at least about 200%: The ABP is the maximal pressure possible in the bore before burst of the flexible unbonded pipe as it is in the offshore system.

The increase of the absolute burst pressure should be determined in relation to the BP as defined above. In other words, ABS minus AB is the increase of the absolute burst pressure due the squeezing pressure.

In one embodiment of the offshore system of the invention, the tensile force in a direction substantially parallel to the center axis directly or indirectly provides a squeezing pressure on the internal sealing sheath, the water directly or indirectly applies a hydrostatic pressure on the internal sealing sheath, the sum of the squeezing pressure and the hydrostatic pressure preferably being sufficiently high to increase the absolute burst pressure ABP in the low pressure armor section with at least about 10%, such as at least about 25%, such as at least about 50%, such as at least about 75%, such as at least about 100%, such as at least about 150%, such as at least about 200%, such as at least about 300.

In one embodiment of the offshore system of the invention, the sum of the squeezing pressure and the hydrostatic pressure is at least 10% higher than the maximal operating pressure in the bore, preferably the sum of the squeezing pressure and the hydrostatic pressure is at least 25% higher such as at least about 50% higher, such as at least about 75% higher, such as at least about 100% higher, such as at least about 150% higher, such as at least about 200% higher, than the maximal operating pressure in the bore.

The squeezing pressure corresponds to the increase of the absolute burst pressure and can accordingly be determined as ABP-AB.

In one embodiment of the offshore system of the invention, the squeezing pressure at least in the low pressure armor section decreases along its length in the direction from the uppermost end towards the lowermost end as a function of the distance to the uppermost end.

In one embodiment of the offshore system of the invention, the hydrostatic pressure at least in the low pressure armor section increases along its length in the direction from the uppermost end towards the lowermost end as a function of the distance to the uppermost end.

In one embodiment of the offshore system of the invention, the pressure in the bore is substantially lower than the ABP while simultaneously exceeding the BP.

### DRAWINGS AND EXAMPLES

The invention will be explained more fully below in connection with some embodiments and with reference to the drawings in which:

FIG. 1 shows a schematical side view of a flexible unbonded pipe of the invention comprising a low pressure armor section.

FIG. 2 shows a schematical side view of a second embodiment of a flexible unbonded pipe of the invention comprising a low pressure armor section.

FIG. 3 shows a schematical side view of a third embodiment of a flexible unbonded pipe of the invention comprising a low pressure armor section.

FIG. 4 shows an offshore system of the invention comprising a flexible unbonded pipe with a low pressure armor section where the flexible unbonded pipe is a riser.

FIG. 5 shows an offshore system of the invention comprising a flexible unbonded pipe with a low pressure armor section where the flexible unbonded pipe is a flow line.

The figures are schematic and may be simplified for clarity. Throughout, the same reference numerals are used for identical or corresponding parts.

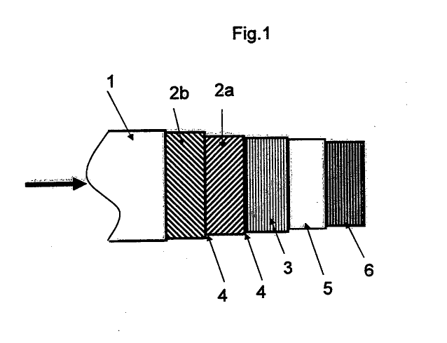

FIG. 1 shows a schematical side view of a flexible unbonded pipe of the invention comprising a low pressure armor section. The part of the flexible unbonded pipe shown is the low pressure armor section and this low pressure armor section may be a part of the length of the flexible unbonded pipe or it may be the whole of the length of the flexible unbonded pipe. The flexible unbonded pipe comprises from inside out a carcass 6, an internal sealing sheath 5, a high pitch outer layer 3, a first tensile armor layer 2a, a second tensile armor layer 2b and an outer sheath 1 (an outer protecting sheath).

Between the high pitch outer layer 3 and the first tensile armor layer 2a as well as between the first tensile armor layer 2a and the second tensile armor layer 2b anti-wear layers indicated with reference number 4 may be arranged to protect the respective layers from wear.

The respective layers may be as described above. In one embodiment the carcass 6, the high pitch outer layer 3 and the first and second tensile armor layers 2a, 2b are made from steel optionally with one or more rubber wires between the elongate elements of the respective wound layers. The weight of the high pitch outer layer 3 per length unit of the flexible unbonded pipe is less than half the weight of the carcass 6 per said length unit.

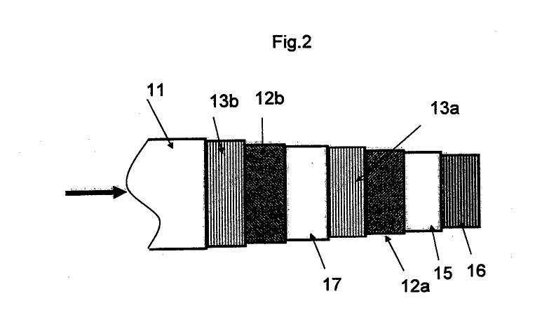

In the flexible unbonded pipe shown in FIG. 2 the low pressure armor section comprises from inside out a carcass 16, an internal sealing sheath 15, a first tensile armor layer 12a, a first high pitch outer layer 13a, a tensile armor intermediate layer 17, a second tensile armor layer 12b, a second high pitch outer layer 13b and an outer sheath 11.

The flexible unbonded pipe may additionally comprise not shown anti-wear layers.

The respective layers may be as described above. In one embodiment the carcass 16, the first high pitch outer layer 13a and the first tensile armor layer are made from steel optionally with one or more rubber wires between the elongate elements of the respective wound layers. The tensile armor intermediate layer 17 is liquid impervious and provides a galvanic barrier layer.

The second tensile armor layer 12b and the second high pitch outer layer 13b are made from polymer/composite material, for example the second tensile armor layer 12b and/or the second high pitch outer layer 13b are made from CFRP.

The total weight of the first and second high pitch outer layers 13a, 13b per length unit of the flexible unbonded pipe is less than half the weight of the carcass 16 per said length unit.

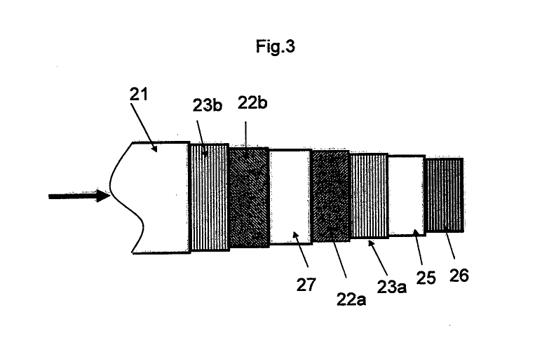

In the flexible unbonded pipe shown in FIG. 3 the low pressure armor section comprises from inside out a carcass 26, an internal sealing sheath 25, a first high pitch outer layer 23a, a first tensile armor layer 22a, a tensile armor intermediate layer 27, a second tensile armor layer 22b, a second high pitch outer layer 23b and an outer sheath 21.

The flexible unbonded pipe may additionally comprise not shown anti-wear layers.

The respective layers may be as described above. In one embodiment the carcass 26, the first tensile armor layer and the first high pitch outer layer 23a are made from steel optionally with one or more rubber wires between the elongate elements of the respective wound layers. The tensile armor intermediate layer 27 is liquid impervious and provides a galvanic barrier layer.

The second tensile armor layer 22b and the second high pitch outer layer 23b are made from polymer/composite material, for example the second tensile armor layer 22b and/or the second high pitch outer layer 23b is made from CFRP.

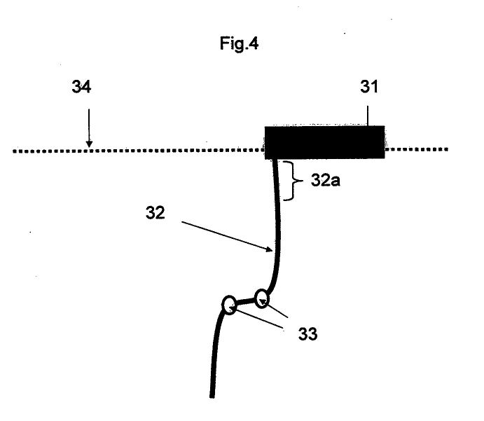

FIG. 4 shows an offshore system of the invention comprising a flexible unbonded pipe 32 with a low pressure armor section 32a. The flexible unbonded pipe 32 is a riser for use in transporting liquid between a sea surface installation 31, such as a ship or a platform and an installation at a certain depth of water e.g. near the seabed. The sea surface is indicated with the line 34. A pair of buoyancy elements 33 are fixed to the flexible unbonded pipe 32 to adjust its configuration. The weight of the flexible unbonded pipe 32 provides a pulling force, which results in that a squeezing pressure of the tensile armor layer(s) is applied to the internal sealing sheath in the low pressure armor section 32a.

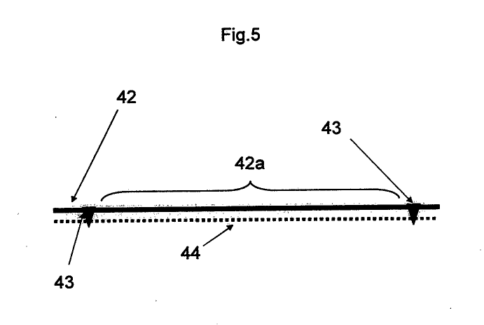

FIG. 5 shows an offshore system of the invention comprising a flexible unbonded pipe 42 with a low pressure armor section 42a. The flexible unbonded pipe 42 is a flow line for use in transporting liquid along the seabed, which is here indicated with the reference number 44. The flexible unbonded pipe 42 is fixed to the seabed 44 by a first and a second fitting 33 arranged on either side of the low pressure armor section 42a, such that the low pressure armor section 42a cannot contract when the pressure is increased inside the flexible unbonded pipe 42. This may result in that a squeezing pressure of the tensile armor layer(s) is applied to the internal sealing sheath in the low pressure armor section 42a.

### EXAMPLE

The following is an example of flexible unbonded pipes of the invention where the flexible unbonded pipes are for use in transport of oil between an installation on the sea bed and a floating installation near the sea surface.

This example describes a freely hanging configuration where the depth of the pipe below the sea surface of the sea is a monotonically increasing function of the length. In this configuration, the hydrostatic pressure around the pipe therefore increases monotonically along the length of the pipe, i.e. as a function of the distance to the sea surface.

The internal sealing sheath is extruded from PVDF and serves to create an effective diffusion barrier to the fluid transported in the pipe. To reinforce the internal sealing sheath against a reduction in volume, the interior of the liner is reinforced with a carcass in the form of a 12 mm thick reinforcement layer made with closely spaced rings of duplex steel forged to high strength.

Outside the internal sealing sheath an anti-creep layer is applied and onto this anti-creep layer the first layer of tensile armor is now helically wound in clockwise direction at a pitch of about 40°. The first tensile armor layer is made from wires of high strength steel and preformed such that the layer is essentially stress free.

When the pipe is pressurized high contact forces will occur between the liner and the subsequent armor layers. The anti-creep layer is applied to prevent creep of liner material into interstices of the wires of the first tensile armor layer. The anti-creep layer consists of a double interlocked layer of steel wire wound onto the liner.

Onto the first tensile armor layer a thermo-mechanical liner (a tensile armor intermediate layer) consisting of 25 mm thick polypropylene is now applied by extrusion. The thermo-mechanical liner serves several purposes. Most importantly the thermo-mechanical liner confines the inner armoring layers and in case of damage of the outer sheath or if the outer sheath is liquid pervious, it prevents water to ingress into the first tensile armor which comprises steel.

Of equal importance, the thermo-mechanical liner acts like a thermal barrier, minimizing heat loss from the bore to the ambient water. At the same time the thermo-mechanical liner reduces the temperature in the subsequent pipe layers. Finally the thermo-mechanical liner acts as galvanic barrier, preventing accelerated corrosion of the first tensile armor layer due to unintended contact between this layer and subsequent armoring layers made from more noble materials as described below.

To reinforce against creep a layer of polyester weave is wound outside the first tensile armor layer prior to extrusion of the thermo-mechanical liner.

Now the second thermal armor layer is wound in a helical counter-clockwise direction onto the pipe. The second thermal armor layer is composed of composite based elongate elements which each are made of thin layers of a CFRP e.g. carbon/epoxy composite (epoxy with carbon fibers) bonded together by thermoplastic intermediate layers. The second thermal armor layer is provided by winding thin layers of the carbon/epoxy composite strips with a first and a second face, where at least one of the faces is coated with a coating of a thermoplastic polyurethane. The thin layers of the carbon/epoxy composite strips are wound counter-clockwise in layers of eight strips placed upon each other. Immediately prior to winding the thin layers of the carbon/epoxy composite strips onto the pipe, the thin layers of the carbon/epoxy composite strips are heated, causing the applied thermoplastic polyurethane to melt. Hereby, the thin layers of the carbon/epoxy composite strips fuse to one or more elongate elements. Since this fusion takes place immediately prior to the application to the pipe, the polyurethane coating will be molten at the winding step, but will harden immediately after application to the pipe.

If the pipe is to be used at great depths of sea, a further lacing of the second reinforcement layer, e.g. at intervals of 10 m, will be an advantage, since this lacing will ensure the position of the reinforcement wires relative to the liner, and also allows the radial travel necessary to prevent mechanical stresses.

To prevent mechanical damage of the second armoring layer an outer sheath is extruded onto the second counter-clockwise wound layer hereby finalizing the main structure of the pipe.

In some cases additional insulation is required for some sections of the pipe according to this example. Where additional thermal insulation is needed, polypropylene tape is wound onto the main structure of the pipe. To protect the additional polypropylene layer an outer protective sheath may be either extruded or wound to complete the insulation layer.

Before deployment of a pipe of the abovementioned type the respective layers thereof should be mounted in an end fitting.

In the end fitting all armoring layers are terminated, as well as the liners. The end fitting according to the present invention is special in that the volume confined between the internal sealing sheath and the thermo-mechanical layer may be vented. The internal sealing sheath as well as the thermo-mechanical layer may be secured with seals, ensuring that the internal sealing sheath as well as the thermo-mechanical layer form a leak-tight layer.

The outer sheath may be either tight or open to fluid transport depending on the exact application of the pipe. If the outer sheath is tight, separate venting of the space formed between the thermo-mechanical layer and the outer sheath may be arranged e.g. in the end fitting.

To prevent damage of the steel layers and end fittings due to galvanic corrosion the CFRP armor should be electrically insulated from the steel parts. This may be done by lining the coupling points for the CFRP armor with glass reinforced epoxy prior to mounting of the CFRP wires.

When deployed to deep waters it is desired that the tensile armor wires support each other, i.e. the spacing between the individual wires may preferably be minimized. This may e.g. be done by squeezing one or more rubber wires between the elongate elements of the respective armor layers.

Some preferred embodiments have been shown in the foregoing, but it should be stressed that the invention is not limited to these, but may be embodied in other ways within the subject-matter defined in the following claims.

What is claimed is:

1. A flexible unbonded pipe having a center axis, and comprising an internal sealing sheath around said center axis defining a bore, a carcass arranged inside said internal sealing sheath, and around said internal sealing sheath the flexible pipe comprises a first tensile armor layer comprising a plurality of helically wound elongate elements having a winding angle to the center axis of about 45 degrees or less, said flexible unbonded pipe comprises at least one high pitch outer layer outside the internal sealing sheath comprising one or more elongate elements wound with an angle to the center axis of at least about 80 degrees and arranged outside said internal sealing sheath, wherein said high pitch outer layer in at least a length section of said flexible unbonded pipe designated a low pressure armor section has a strength relative to the strength of said carcass such that the burst pressure (BP) of the flexible unbonded pipe is about 50% or less than the maximal crushing pressure (CP) of the flexible unbonded pipe determined when the flexible unbonded pipe is lying onshore on a flat horizontal surface and allowed freely to expand/contract as a consequence of an applied pressure during the test.

2-68. (canceled)
